(19) United States
(12) Patent Application Publication
(10) Pub. No.: US 2020/0034784 A1
(43) Pub. Date: Jan. 30, 2020

(54) PRODUCT INVENTORY MANAGEMENT FOR PRODUCT DISPENSERS AT VENUE

(71) Applicant: The Coca-Cola Company, Atlanta, GA (US)

(72) Inventors: Joshua Casey Schwarber, Decatur, GA (US); Stan Kaplita, Sammamish, WA (US)

(21) Appl. No.: 16/526,098

(22) Filed: Jul. 30, 2019

Related U.S. Application Data
(60) Provisional application No. 62/712,085, filed on Jul. 30, 2018.

(51) Int. Cl. G06Q 10/08

(52) U.S. Cl. CPC G06Q 10/087; H04L 67/10

(57) ABSTRACT

A machine and process for providing beverages may include an inventory dispensing apparatus. An input/output (I/O) unit may be configured to communicate data over a communications network to which the I/O unit is in communication. A processing unit may be configured to determine remaining inventory being dispensed by the inventory dispensing machine. A non-transitory memory unit may be in communication with the processing unit, and be configured to store data representative of the remaining inventory. A user interface may be in communication with the processing unit, and be inclusive of an electronic display. At least one other inventory dispensing machine may be in communication with the communications network. The processing unit may be further configured to receive remaining inventory data from the at least one other inventory dispensing machine, store the remaining inventory data from the at least one other inventory dispensing machine on the non-transitory memory unit, and display the remaining inventory data.

### CROSS-REFERENCE TO RELATED APPLICATIONS

This application claims the benefit of priority to U.S. Provisional Application No. 62/712,085, filed Jul. 30, 2018, the disclosure of which is incorporated herein by reference in its entirety.

### FIELD OF THE INVENTION

The present invention relates to a beverage dispenser and to accessing inventory data of other beverage dispensers on a communications network.

### BACKGROUND OF THE INVENTION

Beverage dispensers are used in a variety of venues. Beverage dispensers allow a venue to provide users access to a variety of beverages. Users can pick their preferred beverage and also mix flavors to create new beverages. Giving users access to the beverage dispensers offers the venue a more customer focused business model as well as an opportunity to limit resources and personnel.

Having a self-serve beverage dispenser option allows venues to streamline a portion of the service being provided to customers. For example, soda dispensers and/or coffee dispensers in a restaurant allow for employees of the restaurant to focus on food preparation and customer service, as opposed to constantly refilling beverages for the customers.

However, unfettered access to the beverage dispenser also provides a series of concerns. For example, self-serve beverage dispensers are difficult to monitor and may limit a venue to choosing between employee handling of refills or unlimited refills without any form of regulation or compensation. For example, an employee typically routinely monitors inventory of each flavor at each beverage dispenser to ensure the flavors are not empty or “Sold out.” Since customers are solely interacting with the beverage dispensers, there is no mechanism for estimating an amount of a particular flavor has been dispensed by each dispenser within the venue. Venue personnel have many responsibilities that prevent them from continuously monitoring the dispenser(s), especially within a large venue, such as a movie theater, mall, amusement park, or otherwise.

Additionally, modifications to existing self-serve beverage dispensers should provide some level of uniformity so that operation and maintenance of the beverage dispensers are not unduly burdensome. Conventional inventory management systems are time intensive for personnel, a poor use of resources, and provide little flexibility as to methods of access.

Centralized management stations and remote management stations, which are typically located in a back room or office, may provide the ability for an operator to access inventory information from dispensers. However, response time from a central management station or a remote management station can be prohibitively long. Having an inventory depleted for an extended period of time can be (i) detrimental to the short term and long term satisfaction of customers of the venue, and (ii) potentially be damaging to the reputation of the venue. As understood in the art, the ability for a manager to continuously monitor status of dispensers, such as beverage dispensers, is typically not possible or at a low enough priority that the monitoring does not occur such that venue operators wait to fill dispenser inventory when a customer notifies the operator or the operator happens to notice a sold-out indicator on a dispenser. Hence, improved system processes for notifying venue operators about status of inventory is needed.

### BRIEF SUMMARY OF THE INVENTION

Dispenser machines or dispensers (“machines”) that provide consumer products, such as beverages, for use by consumers may be configured to determine a remaining inventory of items dispensed by the machine. The machine may be in communication with a communications network to communicate directly or indirectly with other machines within a venue. The machine may be configured to communicate remaining inventory data to other machines that are in communication with the communications network. Additionally, the machine may be configured to receive remaining inventory data from the other machines. The machine may display the remaining inventory data of the machines in communication with the communications network on a display and/or user interface of the machine.

One embodiment of a machine for dispensing inventory may include an inventory dispensing apparatus configured to store and dispense inventory. An input/output (I/O) unit may be configured to communicate data over a communications network to which the I/O unit is in communication. A processing unit may be configured to determine remaining inventory being dispensed by the inventory dispensing machine. A non-transitory memory unit may be in communication with the processing unit, and be configured to store data representative of the remaining inventory. A user interface may be in communication with the processing unit, and be inclusive of an electronic display. At least one other inventory dispensing machine may be in communication with the communications network. The processing unit may be further configured to (i) receive remaining inventory data from the at least one other inventory dispensing machine, (ii) store the remaining inventory data from the at least one other inventory dispensing machine on the non-transitory memory unit, and (iii) display the remaining inventory data of the inventory dispensing machine and the at least one other inventory dispensing machine on the user interface so that a user can view the remaining inventory data of the inventory dispensing machine and the at least one other inventory dispensing machine.

One embodiment of a method may include determining remaining inventory being dispensed by an inventory dispensing machine in communication with a communications network. Remaining inventory data may be received from at least one other inventory dispensing machine in communication with the communications network. The remaining inventory data received from the other inventory dispensing machine(s) may be stored on a non-transitory memory unit of the inventory dispensing machine. The remaining inventory data of the inventory dispensing machine and the at least one other inventory dispensing machine may be displayed on a user interface of the inventory dispensing machine so that a user can view the remaining inventory data of the inventory dispensing machine and the other inventory dispensing machine(s).

### BRIEF DESCRIPTION OF THE DRAWINGS

Illustrative embodiments of the present invention are described in detail below with reference to the attached drawing figures, which are incorporated by reference herein and wherein:

FIG. 1 is an illustration of an illustrative machine that dispenses consumer products, such as beverages;

FIG. 2 is an illustration of an illustrative venue including at least two machines that dispense consumer products;

FIG. 3 is an illustration of an illustrative venue including machines that dispense consumer products and display inventory data of machines in communication with a communications network;

FIG. 4 is an illustration of an illustrative back-room machine of a venue in communication with a communications network;

FIG. 5 is an illustration of illustrative inventory data of machines in communication with a communications network;

FIGS. 6A and 6B are illustrations of an illustrative machine configured to display inventory data of the machine and of other machines;

FIG. 7 is an illustration of an illustrative venue network including a machine in communication with a back room server;

FIG. 8 is an illustration of an illustrative method of communicating remaining inventory data;

FIG. 9 is an illustration of an illustrative method of communicating and displaying remaining inventory data, such as sold out notifications;

FIG. 10 is an illustration of an illustrative method of communicating and displaying remaining inventory data of machines in communication with a communications network;

FIG. 11 is an illustration of an illustrative method of determining and displaying remaining inventory data of machines in communication with a communications network;

FIGS. 12A and 12B are illustrations of an illustrative machine inclusive of a set of positions for storing products or ingredients used to create products, and configured to dispense consumer products;

FIG. 13 is an illustration of an illustrative schematic of electronics of a machine configured to dispense consumer products; and

FIG. 14 is an illustration of a block diagram inclusive of illustrative software modules that may form part of software to enable determining, communicating, and displaying remaining inventory data.

### DETAILED DESCRIPTION OF THE INVENTION

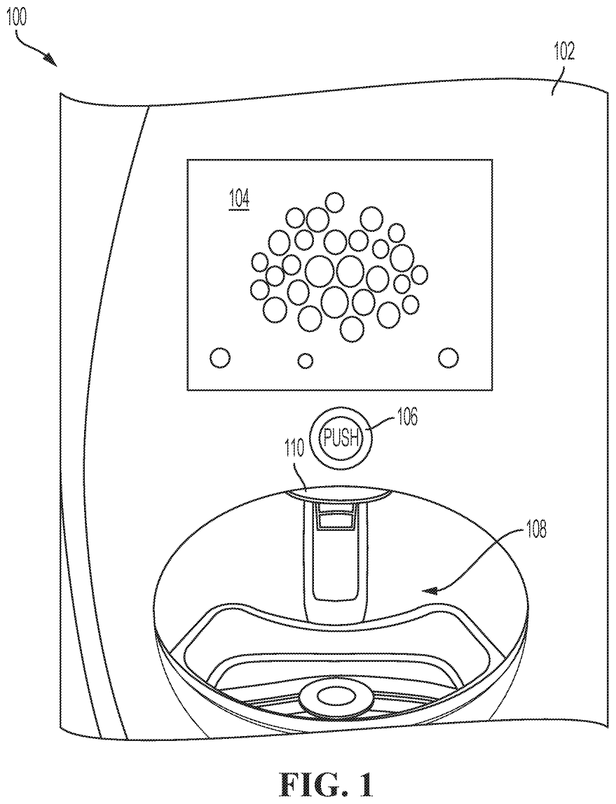

A machine for dispensing consumer products is described in detail below with regard to FIGS. 1-11. In an embodiment, the machine may be configured to determine a remaining inventory of the consumer products, or items, that are dispensed by the machine. The machine may be further configured to receive remaining inventory data about other machines and display the remaining inventory data on a display or user interface. The user may be a consumer or a privileged user, such as an operator or technician. The privileged user may be enabled to view remaining inventory data for machines of a venue in communication with a communications network by accessing any one of the machines. As such, remaining inventory of a particular machine may be inspected by any of the other machines so as to avoid disrupting operation of a machine currently in use by users. Furthermore, the privileged user may be able to obtain remaining inventory data while in a customer facing portion of the venue as opposed to being limited to obtaining the remaining inventory data solely from a back room computer or remote server via any other electronic device.

With regard to FIG. 1, an illustration of an illustrative machine 100 that dispenses consumer products, such as beverages, to consumers is shown. The machine 100 may be a dispenser, but may alternatively be a cooler, vending machine, or any other machine configured to provide consumer products for consumers to purchase or otherwise obtain. In an embodiment, the beverages may be soft-drinks, fruit beverages, still beverages, water, coffee, and so on. The machine 100 may be placed in a venue such as, but not limited to, retail stores, grocery stores, restaurants, malls, sports venues, airports, walkways, or any other public or private location at which a consumer may purchase a consumer product, such as a beverage, from the machine 100.

In one embodiment, the machine 100 may include a dispenser housing 102, a user interface 104 with which a user may interface, a button 106 that may enable the user to start and stop pouring the beverage, and a cavity 108 in which the user may pour beverages. A user may place a vessel inside the cavity 108 beneath a nozzle 110, and press the button 106 to pour a selected beverage via the user interface 104. The machine 100 may also include electronics (not shown) including a processor that is electronically communicative with the user interface 104 and the button 106, so as to control operation of the machine 100. Alternative configurations of the machine 100, such as differently configured dispensing mechanisms, button 106, or otherwise, may be utilized.

The dispenser 102 represents any of a variety of beverage dispensers such as, but not limited to, those discussed hereinabove. Generally, the dispenser 102 may be connected to a pump control (not shown). The pump control may serve as an intermediary between the processor and the dispenser 102. In other embodiments, the dispenser 102 may be connected to a valve with a switch. The toggled switch may allow the valve to open and the beverage may begin to dispense. One of ordinary skill in the art will appreciate that there are a variety of ways to control the dispenser 102. For example, a retrofitted machine may be formed by the dispenser 102 or a conventional dispenser, such as a one, two, six, eight or twelve nozzle dispenser.

The user interface 104 may be any device used for communicating between the user and the machine 100. In one embodiment, the user interface 104 may include a display for displaying messages from the machine 100 to the user. In some embodiments, the display may be a touchscreen display, and may be used to receive input commands from the user. Additionally and/or alternatively, the user interface 104 may include any of a screen, mouse, built-in keyboard, external keyboard, soft-keyboard, remote control, buttons, and/or any other device that a user may employ to interact with the machine 100. One of ordinary skill in the art will appreciate that the user interface 104 may be any of the hereinabove described technologies as well as any other user interface technology. In some embodiments, the user interface 104 may be part of a mobile application on a mobile device. In some embodiments, the machine 100 may be a retrofitted beverage dispenser (also referred to as a legacy system). The retrofitted beverage dispenser may experience limited electrical and mechanical modification.

The machine 100 may be located in a variety of locations in the venue. In some embodiments, the machine 100 may be located behind a service counter, where an employee of the venue interacts with machine 100 on behalf of the user. The machine 100 may be a self-service machine for customers to select and dispense products, such as beverages. Depending on a venue, size and configuration, multiple machines may be co-located or distributed throughout a venue may be available for customers to dispense inventory (e.g., beverages). In some embodiments, the machine 100 may be configured to provide free samples, at a substantially low volume, to the user. Additionally, the machine 100 may be in communication with a network, such as the Internet, in a “cloud” configuration, a local communications network, and/or a server.

The cloud and/or communications network may be any network, device, or combination of devices configured to provide data to the user. The cloud and/or communications network may include storage devices that store content requested by users at the machine 100. The cloud and/or communications network may include any variety of routers, servers, bridges, switches, and combinations of such devices that provide connectivity between the machine 100, storage devices, and other machines (e.g., dispensers). In one embodiment, the communications network is local to the venue. The communications network may be wired (e.g., Ethernet) and/or wireless (e.g., Bluetooth, WiFi). The communications network may be a local area network (LAN) or wide area work (WAN). The communications network may be cellular and/or the Internet. In one embodiment, a plurality of machines are in communication with the communications network.

The vessel may be any beverage container, such as, but not limited to, cups, glasses, thermoses, mugs, bottles, and any other device that holds a beverage for a user to drink. The vessel may include any shape, size, or volume. If the machine is configured to dispense other consumable items, such as foodstuffs, alternative vessel configurations may be utilized. In one embodiment, the dispenser 102 is configured to dispense non-consumable inventory.

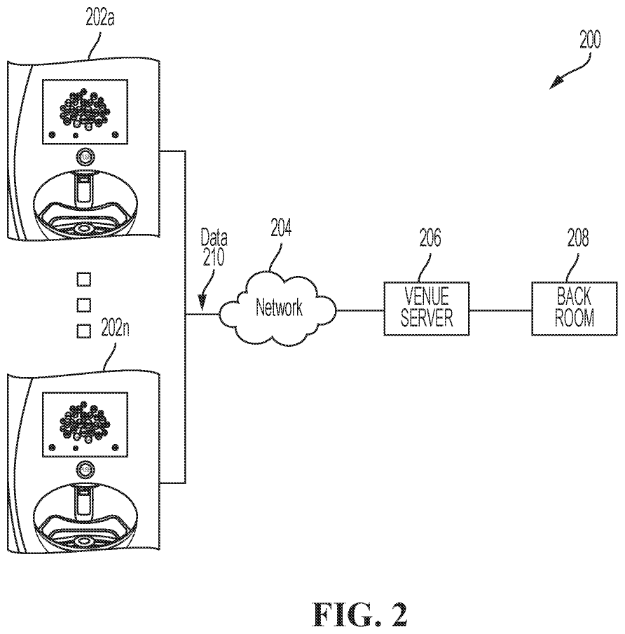

With regard to FIG. 2, an illustration of an illustrative venue 200 including multiple machines 202a-202n (collectively 202) that dispense consumer products is shown. The venue 200 may also include a network 204, such as the communications network as described hereinabove, a venue server 206 (or cloud server), and a computing devices available in back room 208 that can access remaining inventory data 210 that may be transmitted from the machine 202 to the network 204. The data 210 may represent information regarding remaining inventory (or any other information associated with or derived from inventory of the machines 202). The inventory may be consumable or non-consumable. In one embodiment, the inventory may be consumable and may be at least one of a beverage and an ingredient that is mixed with at least one other ingredient to produce a beverage, as understood in the art. The consumable inventory may additionally and/or alternatively include solid (e.g., candy) or non-solid (e.g., ice cream) food. The consumable inventory may be packaged food or beverages, as well. Non-consumable inventory may be electronics, accessories, or any other products capable of being dispensed.

The machines 202 may be configured to transmit and receive the data 210 representative of remaining inventory from other machines on the network. In one embodiment, the data 210 may be transmitted between the machines 202 directly. In such an embodiment, one of the machines 202 may be configured as a master and the remaining machines may be configured as slaves. Alternatively, each machine may broadcast the data 210 to each other machine so all of the machines have inventor information of each other machine, thereby allowing for an operator to view inventory of each machine from any of the machines 202. In one embodiment, the data 210 may be transmitted by the machines 202 via the network 204 in a secured or unsecured manner, and be stored on the venue server 206. Other machines of the machines 202 may then access the data 210 from other machines on the venue server 206. As a result, remaining inventory data of the machines 210 may be viewed on any machine of the machines 202.

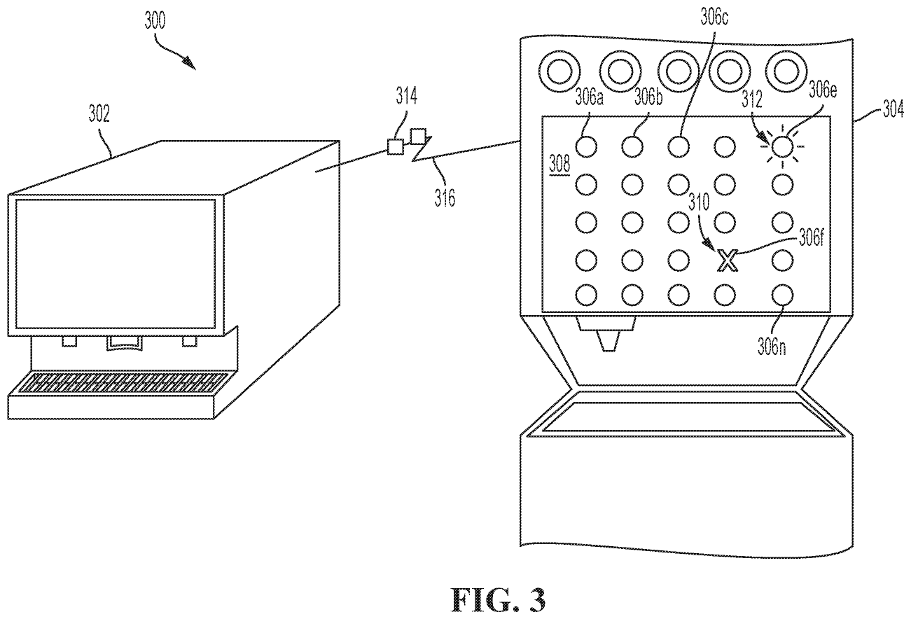

With regard to FIG. 3, an illustration of an illustrative venue 300 including machines that dispense consumer products and display inventory data of machines in communication with a communications network is shown. A first dispenser 302 and a second dispenser 304 may be in communication with the communications network. The second dispenser 304 may display items or logos 306a-306n (collectively 306) of inventory items on a user interface 308. The items 306 may have associated symbols that indicate remaining inventory of the items 306. In one embodiment, symbol 310 may be a crossed-out icon (e.g., “x” over the icon), which is indicative of a beverage associated with the item 306f being sold-out. In one embodiment, symbol 312 may shine around the item 306e and may represent that the item 306e is nearing depletion. In another embodiment, gauges, numbers, or any other symbol that are indicative of remaining inventory may be displayed for a user to view.

The items 306 may represent remaining inventory of the second dispenser 304 or remaining inventory of another dispenser in communication with the communications network, such as the first dispenser 302. The first dispenser 302 may communicate data 314 via a communications network 316 to the second dispenser 304 by any of a number of methods of electrical communication, such as those described hereinabove. One of skill in the art will appreciate that many methods of wired and/or wireless electrical communications protocols exist for communicating the data 314. The data 314 may be indicative of remaining inventory data of the first dispenser 302 that may be displayed on the user interface 308 of the second dispenser 304. For example, the data 314 may include inventory items and remaining balances of the respective inventory items. FIG. 3 represent two dispensers in communication with a communications network. However, one of skill in the art will appreciate that any number of dispensers may be in communication with the communications network as well as any other methods of local or wide area networking.

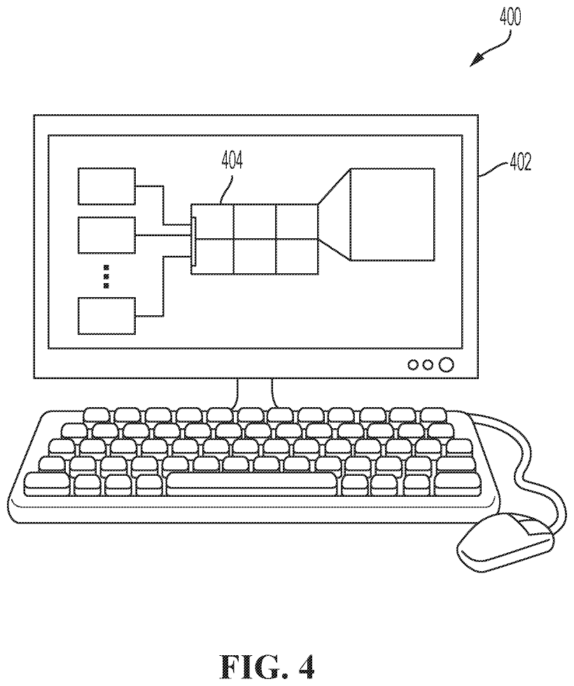

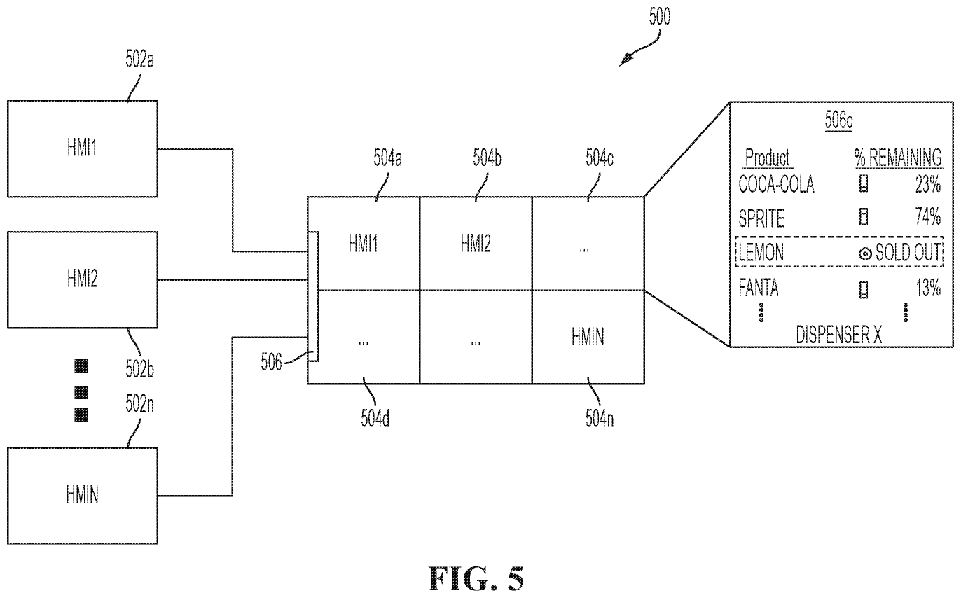

With regard to FIG. 4, an illustration of an illustrative back-room computing device 400 of a venue in communication with a communications network on which dispensing machines(s) are in communication is shown. The back-room computing device 400 may include a user interface 402. The user interface 402 may be configured to display inventory data 404 of machines in communication with the communications network. An embodiment of the inventory data 404 is described further in regards to FIG. 5. In an embodiment, if the products or product ingredients are located in a back room, then the same or similar product and/or product ingredient remaining inventory amounts may be determined and made available at any of the machines or back-room computing device 400.

The user interface 402 may be any device used for communicating between the user and the computing devices 400. In one embodiment, the user interface 402 may include a display for displaying messages from the computing device 400 to the user. In some embodiments, the display 402 may be a touchscreen display, and may be used to receive input commands from the user. Additionally and/or alternatively, the user interface 402 may include any of a screen, mouse, built-in keyboard, external keyboard, soft-keyboard, remote control, buttons, and/or any other device that a user may employ to interact with the computing devices 400. One of ordinary skill in the art will appreciate that the user interface 402 may be any of the hereinabove described technologies as well as any other user interface technology. In some embodiments, the user interface 402 may be part of a mobile application on a mobile device. The computing device 400 may be configured to replicate real-time information being displayed on a dispensing machine in the venue. In one embodiment, the computing device 400 may be configured to display items indicative of remaining inventory of items (e.g., ingredients) being dispensed by a machine, where the information displayed on the user interface 402 may be the same, similar, or different in format as would be displayed on the machine(s) in the venue.

With regard to FIG. 5, an illustration of illustrative inventory data 500 of machines 502a-502n (collectively 502) in communication with a communications network is shown. The machines 502 may communicate remaining inventory data to an input/output (I/O) unit 506 of a machine. Machine selections 504a-504n (collectively 504) may represent the machines 502. A user may select one of the machine selections 504 to view a full screen mode of inventory data of the machine 502c associated with the machine selection 504c selected by the user.

The full screen mode 508 may a visual representation of the remaining inventory data received from the machines 502. In one embodiment, the full screen mode 508 may be configured to further include, or be controlled to include, diagnostic data of a machine 502c associated with the machine selection 504c. One of skill in the art will appreciate that any of a number of data points may be displayed about a machine on a different machine and be utilized by the user. In one embodiment, the user is a privileged user, such as, but not limited to, a technician, an operator, or a venue personnel, and the data displayed in the full screen mode 508 may represent information relevant to the type of privileged user. For example, temperatures, pressures, and/or any other operational parameters of any machine may be available for an operator or technician to view on any of the other machines. The machines 502 may be described as human machine interfaces (HMIs), beverage dispensers, dispenser, machines, and other terms indicative of a machine configured to dispense a consumer product.

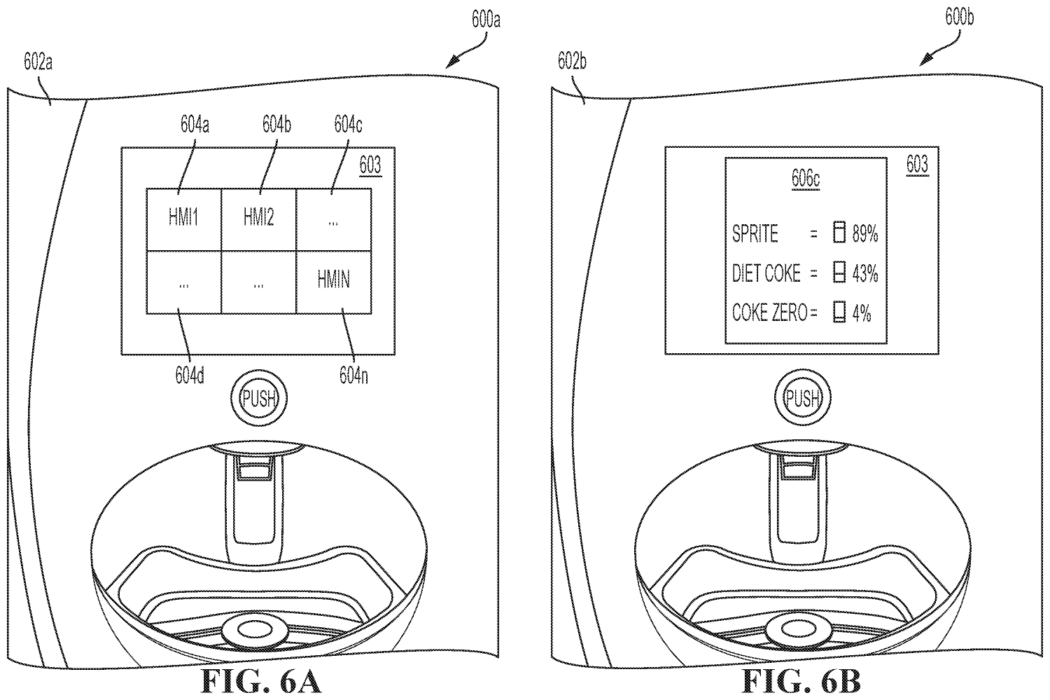

With regard to FIGS. 6A and 6B, illustrations of an illustrative machine 600a and 600b (collectively 600) configured to display inventory data of other machines are shown. The machine 600 may include an inventory dispensing apparatus 602a and 602b (collectively 602) with a user interface 603. The dispenser may be configured to display machine selections 604a-604n (collectively 604) to select inventory and/or operational data associated with respective machines 600. The machine selections 604 may represent the machine 600 and other machines in communication with a communications network.

In an embodiment of an operation of the machine 600, in response to a user selecting a machine selection 604c, the user may view a full screen mode 606c including data of the machine selection 604c. The data may include remaining inventory data and optionally other data, such as operational data, of the machine associated with the machine selection 604c. In one embodiment, software being executed by electronics (e.g., processing unit and/or memory unit) of the machine 600 may be configured to determine a type of user accessing the machine. If the type of user is determined to be a privileged user, the machine 600 may be configured to display data relevant to the privileged user of the machine selection 604c in the full screen mode 606c. For example, the data relevant to the privileged user may include remaining inventory data, operational data, and/or maintenance data.

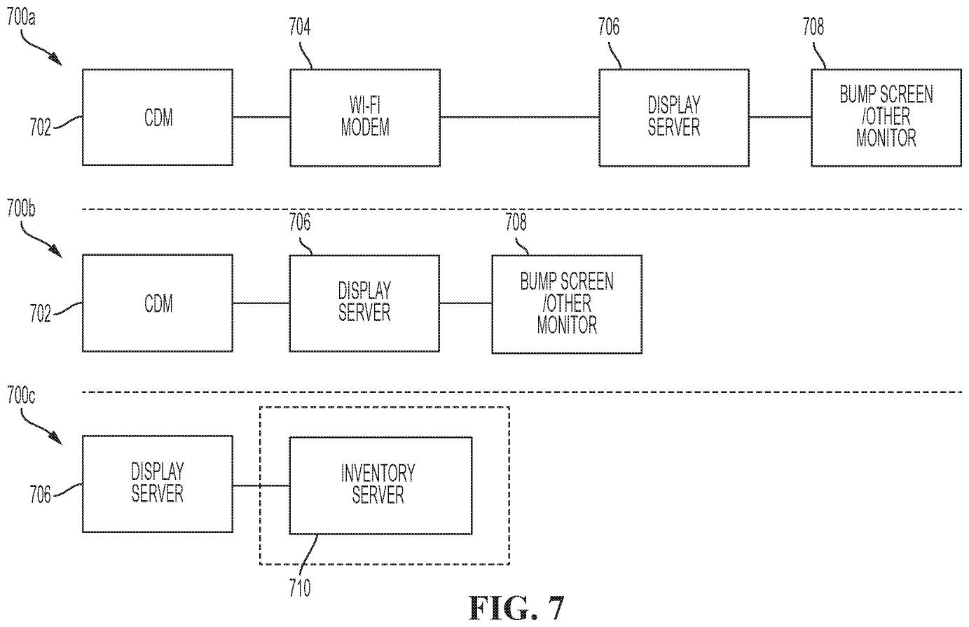

With regard to FIG. 7, an illustration of an illustrative venue network 700a, 700b, 700c (collectively 700) including a machine in communication with a back room server is shown. In one embodiment of the venue described hereinabove with regard to FIGS. 1-6, the venue may include the back room or cloud-based server. In one embodiment of the venue network 700a, a core dispense module (CDM) 702 of a dispenser may be in electrical communication, via a wireless connection 704, such as a Wi-Fi modem, with a display server 706. The display server 706 may be in electrical communication of a bump screen and/or other user interface 708, such as a monitor, of the display server 706.

In another embodiment of the venue network 700b, the core dispense module 702 may be electrically coupled to the display server 706. The display server 706 may be in electrical communication with the monitor 708. In yet another embodiment of the venue network 700c, the display server 706 may be in electrical communication with an inventory server 710 that may collect inventory from each of the machine on the venue network 700c. One of skill in the art will appreciate that many network configurations exist for communicating data between multiple machines in a venue. One of skill in the art will also appreciate that configurations may either centralize the data, such as with a back room or other network server, or distribute the data throughout the machines of the venue (i.e., one or more machines may share and/or collect remaining inventory data of other machines at a venue). In yet another embodiment, at least one machine of the machines of the venue may be configured to act as a centralized server.

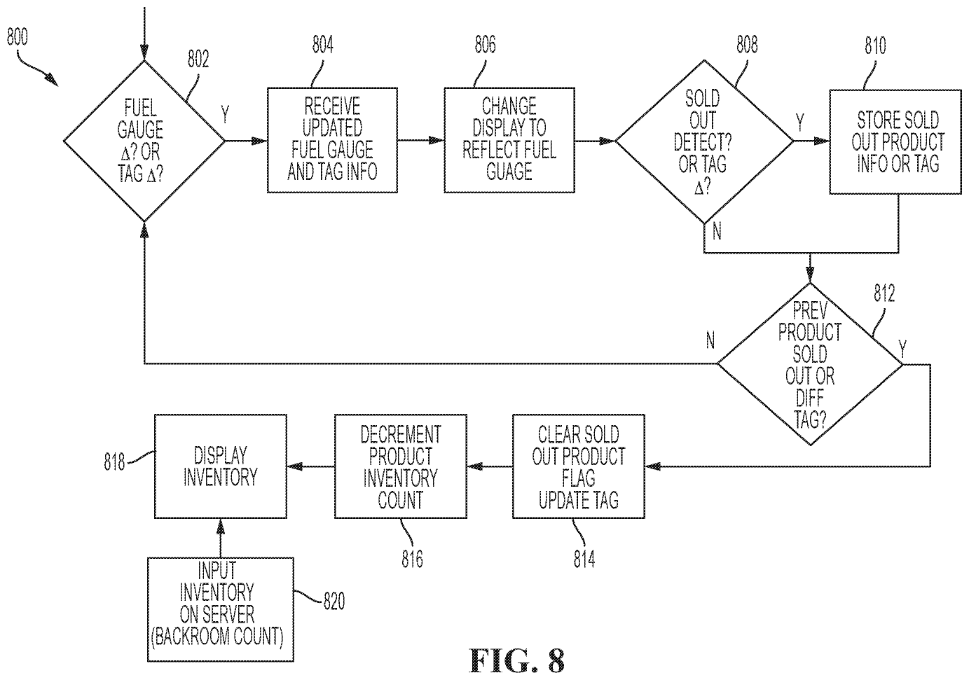

With regard to FIG. 8, an illustration of an illustrative process 800 of communicating and tracking remaining inventory data of dispenser machine(s) is shown. A machine may determine at step 802 if there is a difference in a fuel gauge or tag data indicative of a change in inventory of an item of the machine. If a change in inventory is detected, the machine may receive updated fuel gauge or tag information (i.e., inventory data) at step 804. The machine may change a display of a user interface to reflect the updated inventory level at step 806.

At step 808, the machine may determine if the updated inventory level is indicative of an inventory being sold out or if a different tag is identified. If no sold out indication or different tag is identified at step 808, the process 800 may proceed to step 812. If a sold out identifier or a different tag is identified at step 808, then the machine may store the sold out product information or the different tag information at step 810 and then proceed to step 812.

The machine may determine if a previous product sold out or if a different tag was identified at step 812. If no previous product sold out and if no different tag was identified, the method 800 may return to gauging inventory and evaluating tag information at step 802. If a previous product sold out or if a different tag was identified at step 812, the machine may clear a sold out product flag or update the tag information at step 814. A product inventory count may be decremented at step 816 and the inventory may be displayed at step 818. In one embodiment, steps 816 and 818 may be performed by a back room server. The back room server may also input inventory at step 820 and then display the inventory at step 818. It should be understood that the back room server may alternatively be a cloud server and the cloud server may operate as a back room server.

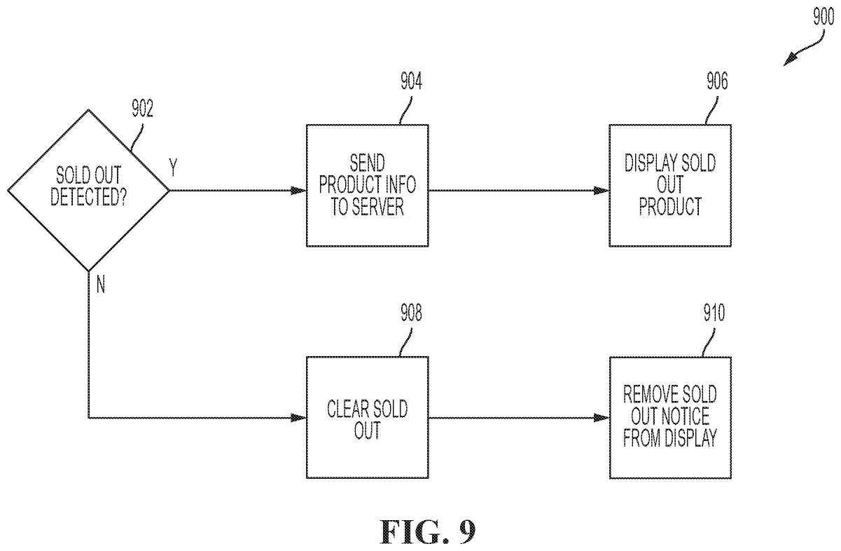

With regard to FIG. 9, an illustration of an illustrative method 900 of communicating, tracking, and displaying remaining inventory data, such as sold out notifications, is shown. A machine may determine at step 902 if inventory of a product or ingredient of a beverage, for example, is sold out. If the inventory is sold out, the machine sends or communicates product information indicative of the product being sold out to a server at step 904. In one embodiment, the machine may communicate the product information via a communications network to other machines in communication with the communications network. The machine may then display a sold out notification on a user interface of the machine at step 906.

If inventory of a product is determined as not being sold out at step 902, the machine may clear a sold out status at step 908. In one embodiment, the machine may automatically communicate to the server that the sold-out status is to be cleared in response to an operator replacing an ingredient cartridge or other inventory item, for example. In another embodiment, the machine may be configured to be updated by an operator that the product (or ingredient thereof) has been replaced and cause the machine to communicate an update. In one embodiment, the sold out status is stored local to the machine, and the sold out status is cleared by electronics and software internal to the machine. In one embodiment, a clear sold out status communication may be made to other machines in communication with the communications network. The machine may then remove the sold out notification on the user interface at step 910. One of skill in the art will appreciate that many methods of networking and communication exist for communicating remaining inventory data to machines of a venue.

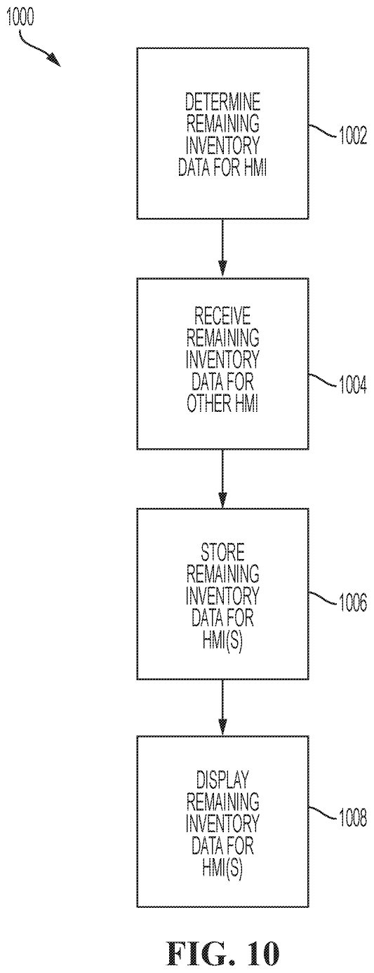

With regard to FIG. 10, an illustration of an illustrative process 1000 of communicating, tracking, and displaying remaining inventory data of machines in communication with a communications network is shown. A machine may determine remaining inventory data for the machine at step 1002. The remaining inventory data may be displayed on a human machine interface. The machine may receive remaining inventory data for other machines in communication with the communications network at step 1004, and display or make available for display the other inventory data. The machine may store the remaining inventory data for the machines in communication with the communications network at step 1006. The machine be configured to display the remaining inventory data of the machines in communication with the communications network at step 1008.

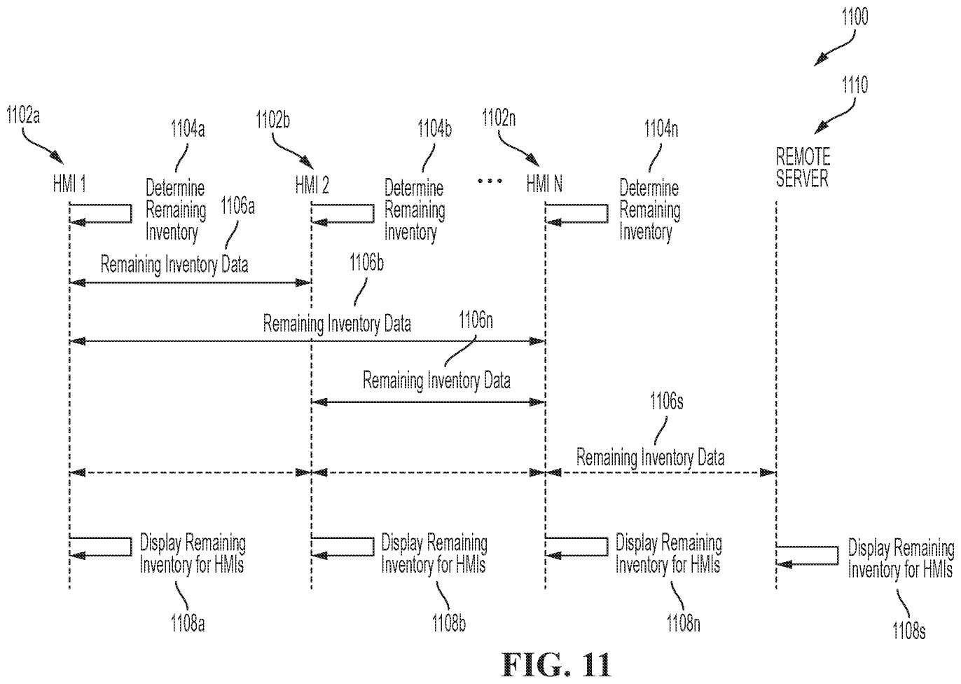

With regard to FIG. 11, an illustration of an illustrative method 1100 of determining and displaying remaining inventory data of machines 1102a-1102n (collectively 1102) in communication with a communications network is shown. The machines 1102 may determine a remaining inventory at steps 1104a-1104n (collectively 1104). The machines 1102 may communicate the remaining inventory data with other machines in communication with the communications network at steps 1106a-1106n (collectively 1106). The machines may be configured to selectably display remaining inventory data for any or all of the machines 1102 in communication with the communications network at steps 1108a-1108n (collectively 1108).

In one embodiment, a remote server 1110 that may be at or outside of a venue in which the machines 1102 are located may be in communication with the communications network. The machines 1102 may be further configured to communicate the remaining inventory data to the remote server at step 1106s. Similarly, the remote server 1110 may be configured to communicate the remaining inventory data 1106 to the machine(s) 1102 at step 1106s. The communication 1106 of the remaining inventory data may be performed as a broadcast communication or responsive to a query from any of the machines 1102 or server 1110. The remote server may be configured to display remaining inventory data for the machines in communication with the communications network at step 1108s.

It should be understood that the machines may or may not be the same, and that inventory dispensed by the machines in a venue may or may not be the same.

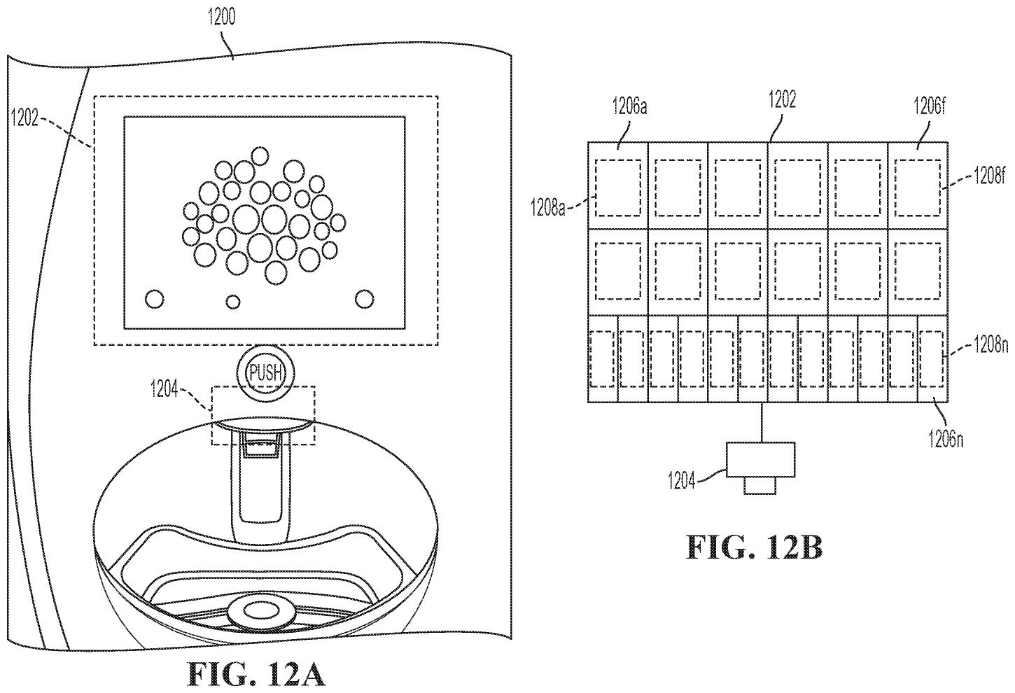

With regard to FIGS. 12A and 12B, illustrations of an illustrative machine 1200 inclusive of a dispensing apparatus 1202 used to store, produce, and dispense consumer products, are shown. The inventory dispensing apparatus 1202 may be fluidly coupled to a nozzle 1204 for dispensing a beverage including one or more ingredients. The inventory dispensing apparatus 1202 may include a set of positions 1206a-1206n (collectively 1206) in which ingredients, such as micro-ingredients, may be stored. In one embodiment, the set of positions 1206 may include three rows of twelve positions, where the first two rows are the first set of positions having first dimensions and the third row is the second set of positions having second dimensions. It should be understood that alternative configurations of the positions 1206 may be utilized.

In one embodiment, the first set of positions may be configured to contain a first set of ingredients, such as macro-ingredients. The second set of positions may be configured to contain a second set of ingredients, such as micro-ingredients. In an embodiment, all of the ingredients are micro-ingredients, and macro-ingredients may be positioned in containers outside of the machine 1200. The ingredients, whether micro or macro, may be housed in containers 1208a-1208n (collectively 1208) (shown dashed in FIG. 12) such as, but not limited to, pouches, bags, and/or boxes. Of course, if macro ingredients, the containers are generally significantly larger than containers of micro-ingredients.

There are a few types of beverage ingredients, including micro-ingredients, macro-ingredients, and a middle level of ingredients. Micro ingredients are generally acids and flavors that are highly concentrated and are able to produce a beverage using a high ratio (e.g., 150:1) of water or other beverage ingredient to the micro ingredient. Macro ingredients also include acids and flavors that are less concentrated and are used at a lower ratio (e.g., 5:1) of water or other beverage ingredient to the macro ingredient. Other mid-level ingredients may be used in concentration ratios (e.g., 50:1) that are between the micro- and macro-ingredients.

Because the micro-ingredients can be used in such high ratio concentrations, the micro-ingredients may be stored in containers, such as half-liter pouches, and still provide for a sufficient number of beverage dispenses in a typical food outlet, such as a restaurant, of an operator of the machine 1200. Macro-ingredients are stored in containers that are much larger, such as 2.5, 3, or 5 gallon bags. As a result, in one embodiment, the first set of positions may be configured to be larger than the second set of positions. In other embodiments, the first set of positions and second set of positions may be substantially the same size. Still yet, other configurations of the inventory dispensing apparatus 1202 may position the sets of positions 1206 outside of the machine 1200, such as in a separate cabinet or even in a separate room, and receive fluids of the ingredients via lines that extend through a cabinet or wall, for example.

In operation, an operator may open and/or remove a front panel of the machine 1200 to access the set of positions 1206. The operator may further install, maintain, or replace the macro-ingredients and/or micro-ingredients by adding, checking, or replacing the containers 1208. The inventory dispensing apparatus 1206 may be fluidly coupled to a nozzle 1204 that may be configured to dispense a selection by the user into a vessel.

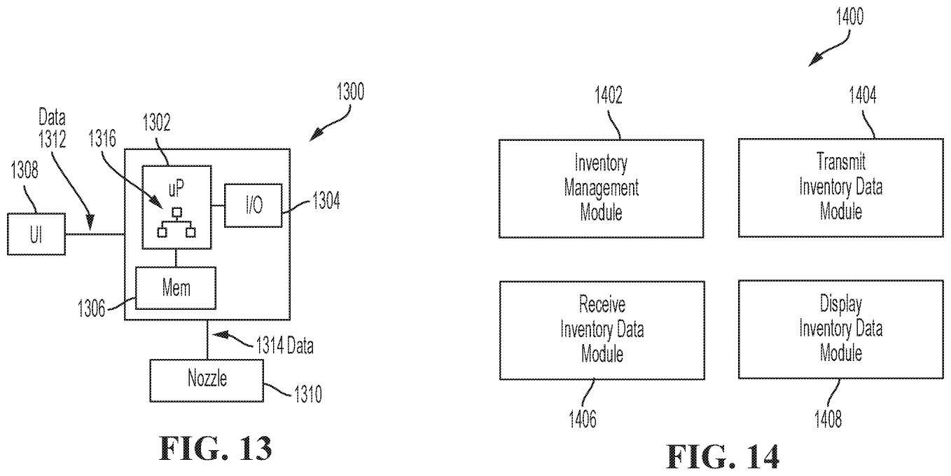

With regard to FIG. 13, an illustration of an illustrative schematic of electronics 1300 of a machine configured to dispense consumer products is shown. The electronics 1300 may include a processing unit 1302, an input/output (I/O) unit 1304, a memory unit 1306, a user interface 1308, and a nozzle 1310, such as the nozzle 1204 of FIG. 12.

The processing unit 1302 may be implemented using one or more general purpose processors, one or more cores (e.g., a multi-core processor), image processors, digital signal processors (DSPs), one or more application specific integrated circuits (ASICs), and/or other processing circuitry. Alternatively, the processing unit 1302 may be formed of analog or other circuitry. The processing unit 1302 may be configured to implement any of the processes described herein, and may be implemented using hardware, software, firmware, or combinations thereof. The processing unit 1302 may be configured to execute software 1316 that performs certain functions, as further described herein

The processing unit 1302 may be in communication with the I/O unit 1304 and the memory unit 1306. The I/O unit 1304 may be configured to communicate with the communications network of the venue and with the user interface 1308 that enables a user to select and pour beverages, as previously described. The processing unit 1302 and user interface 1308 may also enable an operator to receive messages, such as remaining inventory data, error messages, notifications, and alerts during servicing, as further described herein. The user interface 1308 and the nozzle 1310 may be configured to communicate data 1312 and 1314 to the processing unit 1302 and the I/O unit 1304.

With regard to FIG. 14, an illustration of a block diagram inclusive of illustrative software modules 1400 that may form part of the software 1316 of FIG. 13 to enable determining, communicating, and displaying remaining inventory data is shown. The software modules 1400 may include an inventory management module 1402 for determining remaining inventory (e.g., amount of ingredients, number of consumer products) and tracking the remaining inventory data of a machine and/or other machines. A transmit inventory data module 1404 may configured to transmit the remaining inventory data of the machine to other machines in communication with a communications network. A receive inventory data module 1406 may be configured to receive remaining inventory data of the other machines, and store the remaining inventory data in a memory unit with non-transitory memory of the machine. A display inventory data module 1408 may configured to display the remaining inventory data of the machine and/or the other machines on a user interface of the machine.

The foregoing method descriptions and the process flow diagrams are provided merely as illustrative examples and are not intended to require or imply that the steps of the various embodiments must be performed in the order presented. As will be appreciated by one of skill in the art, the steps in the foregoing embodiments may be performed in any order. Words such as “then,” “next,” etc., are not intended to limit the order of the steps; these words are simply used to guide the reader through the description of the methods. Although process flow diagrams may describe the operations as a sequential process, many of the operations may be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed here may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to and/or in communication with another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description here.

When implemented in software, the functions may be stored as one or more instructions or code on a non-transitory computer-readable or processor-readable storage medium. The steps of a method or algorithm disclosed here may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used here, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The previous description is of a preferred embodiment for implementing the invention, and the scope of the invention should not necessarily be limited by this description. The scope of the present invention is instead defined by the following claims.

What is claimed:

1. An inventory dispensing machine, said machine comprising:
an inventory dispensing apparatus configured to store and dispense inventory;
an input/output (I/O) unit configured to communicate data over a communications network to which said I/O unit is in communication, at least one other inventory dispensing machine being in communication with the communications network;
a processing unit configured to determine remaining inventory being dispensed by said inventory dispensing machine;
a non-transitory memory unit in communication with said processing unit, and configured to store data representative of the remaining inventory; and
a user interface in communication with said processing unit, and inclusive of an electronic display, said processing unit further configured to:
receive remaining inventory data from the at least one other inventory dispensing machine;
store the remaining inventory data from the at least one other inventory dispensing machine on said non-transitory memory unit; and
display the remaining inventory data of said inventory dispensing machine and the at least one other inventory dispensing machine on said user interface so that a user can view the remaining inventory data of said inventory dispensing machine and the at least one other inventory dispensing machine.

2. The inventory dispensing machine according to claim 1, wherein said processing unit is further configured to request the remaining inventory data from the at least one other inventory dispensing machine.

3. The inventory dispensing machine according to claim 2, wherein said processing unit is further configured to request the remaining inventory data from the at least one other inventory dispensing machine in response to a request by the user.

4. The inventory dispensing machine according to claim 1, wherein the inventory is a consumable inventory.

5. The inventory dispensing machine according to claim 4, wherein the consumable inventory includes at least one of a beverage and an ingredient that is mixed with at least one other ingredient to produce a beverage.

6. The inventory dispensing machine according to claim 1, wherein said processing unit is further configured to transmit the remaining inventory data of said inventory dispensing machine to the at least one other inventory dispensing machine.

7. The inventory dispensing machine according to claim 6, wherein said processing unit is further configured to transmit the remaining inventory data of said inventory dispensing machine to the at least one other inventory dispensing machine in response to a request by a user of the at least one other inventory dispensing machine.

8. The inventory dispensing machine according to claim 1, wherein said processing unit is further configured to:
in response to the user requesting an item of or produced by the inventory, determine whether the item is available based on remaining inventory data; and
in response to the remaining inventory data being indicative of the item being sold out, display an alternative inventory dispensing machine in communication with the communications network and including remaining inventory data indicative of a positive balance of the item, otherwise, notify the user that the item is unavailable from any of the inventory dispensing machines.

9. The inventory dispensing machine according to claim 1, wherein said processing unit is further configured to determine if the user is a privileged user.

10. The inventory dispensing machine according to claim 9, wherein said processing unit, in response to determining the user is the privileged user, is further configured to display a message indicative of all sold-out inventory on each inventory dispensing machine in communication with the communications network.

11. A method, comprising:
determining remaining inventory being dispensed by an inventory dispensing machine in communication with a communications network;
receiving remaining inventory data from at least one other inventory dispensing machine in communication with the communications network;
storing the remaining inventory data from the at least one other inventory dispensing machine on a non-transitory memory unit of the inventory dispensing machine; and
displaying the remaining inventory data of the inventory dispensing machine and the at least one other inventory dispensing machine on a user interface of the inventory dispensing machine so that a user can view the remaining inventory data of said inventory dispensing machine and the at least one other inventory dispensing machine.

12. The method according to claim 11, further comprising requesting the remaining inventory data from the at least one other inventory dispensing machine.

13. The method according to claim 12, wherein the requesting the remaining inventory data from the at least one other inventory dispensing machine includes requesting the remaining inventory data from the at least one other inventory dispensing machine in response to a request by the user.

14. The method according to claim 11, wherein the determining remaining inventory includes determining remaining consumable inventory.

15. The method according to claim 14, wherein the determining remaining consumable inventory includes determining at least one of a remaining beverage and a remaining ingredient mixed to produce a beverage.

16. The method according to claim 11, further comprising transmitting the remaining inventory data of said inventory dispensing machine to the at least one other inventory dispensing machine.

17. The method according to claim 16, wherein the transmitting the remaining inventory data of said inventory dispensing machine to the at least one other inventory dispensing machine includes transmitting the remaining inventory data of said inventory dispensing machine to the at least one other inventory dispensing machine in response to a request by a user of the at least one other inventory dispensing machine.

18. The method according to claim 11, further comprising:
in response to the user requesting an item of or produced by the inventory, determining whether the item is available based on remaining inventory data; and
in response to the remaining inventory data being indicative of the item being sold out, displaying an alternative inventory dispensing machine in communication with the communications network and including remaining inventory data indicative of a positive balance of the item, otherwise, notifying the user that the item is unavailable from any of the inventory dispensing machines.

19. The method according to claim 11, further comprising determining if the user is a privileged user.

20. The method according to claim 19, further comprising, in response to determining the user is the privileged user, displaying a message indicative of all sold-out inventory on each inventory dispensing machine in communication with the communications network.
